(19) United States
(12) Patent Application Publication
(10) Pub. No.: US 2018/0039988 A1
(43) Pub. Date: Feb. 8, 2018

(54) METHODS FOR CONTROLLING ACCESS TO A FINANCIAL ACCOUNT

(71) Applicant: MASTERCARD INTERNATIONAL INCORPORATED, Purchase, NY (US)

(72) Inventor: Sudhir Gupta, Pune (IN)

(21) Appl. No.: 15/661,424

(22) Filed: Jul. 27, 2017

(30) Foreign Application Priority Data
Aug. 3, 2016 (SG) 10201606405R

(51) Int. Cl. G06Q 20/40

(52) U.S. Cl. CPC G06Q 20/4014; G06Q 20/34

(57) ABSTRACT

Disclosed herein are systems and methods for controlling financial account access. In one aspect, a method is provided, including storing a financial account in a database, having details of one or more payment vehicles and a mobile phone number, and associating, in the database, a unique access token with the financial account. A request to access the financial account is then received through a computing system, the request including the access token that is cross-referenced against the database, to identify the financial account associated with the access token, and identifying the mobile phone number from the financial account. A verifier, authorized to access the financial account, is then sent to the mobile phone number. Access is granted to the financial account through the computing system if the verifier is subsequently received through the computing system; access is denied if the verifier is not subsequently received through the computing system.

### TECHNICAL FIELD

The present disclosure relates to methods for controlling access to financial accounts.

### BACKGROUND

The modern day financial environment relies increasingly on the use of payment cards—for example, credit and debit cards—to enable transactions. Such cards are presented in-store at a point-of-sale (POS) terminal, entered into a payment gateway in an online environment, and are also used to access automated teller machines (ATMs).

The number of credit and debit cards in circulation, the prevalent usage of such cards, and the need to transmit card details between millions of different locations make it a challenge to keep card details secure from fraudulent acquisition and usage.

It is desirable therefore that such cards can still be used to enable financial transactions without transmitting card details over unsecure networks.

### SUMMARY

In accordance with the present disclosure there is provided a method for controlling financial account access, comprising the steps of:
storing a financial account in a database, the financial account comprising details of one or more payment vehicles and a mobile phone number;
associating, in the database, a unique access token with the financial account;
receiving, through a computing system, a request to access the financial account, the request comprising the access token;
cross-referencing the access token against the database, to identify the financial account associated with the access token, and identifying the mobile phone number from the financial account;
sending, to the mobile phone number, a verifier for verifying the user is authorised to access the financial account; and
granting access to the financial account through the computing system if the verifier is subsequently received through the computing system, and denying access to the financial account if the verifier is not subsequently received through the computing system.

The present disclosure also provides a computer system for controlling financial account access, the computer system comprising:
a memory device for storing data;
a display; and
a processor coupled to the memory device and being configured to:
store a financial account in a database, the financial account comprising details of one or more payment vehicles and a mobile phone number;
associate, in the database, a unique access token with the financial account;
receive, through a computing system, a request to access the financial account, the request comprising the access token;
cross-reference the access token against the database, to identify the financial account associated with the access token, and identifying the mobile phone number from the financial account;
send, to the mobile phone number, a verifier for verifying the user is authorised to access the financial account; and
grant access to the financial account through the computing system if the verifier is subsequently received through the computing system, and denying access to the financial account if the verifier is not subsequently received through the computing system.

The present disclosure still further provides a computer program embodied on a non-transitory computer readable medium for controlling financial account access, the program comprising at least one code segment executable by a computer to instruct the computer to:
store a financial account in a database, the financial account comprising details of one or more payment vehicles and a mobile phone number;
associate, in the database, a unique access token with the financial account;
receive, through a computing system, a request to access the financial account, the request comprising the access token;
cross-reference the access token against the database, to identify the financial account associated with the access token, and identifying the mobile phone number from the financial account;
send, to the mobile phone number, a verifier for verifying the user is authorised to access the financial account; and
grant access to the financial account through the computing system if the verifier is subsequently received through the computing system, and denying access to the financial account if the verifier is not subsequently received through the computing system.

### BRIEF DESCRIPTION OF THE DRAWINGS

Some examples of the concept discussed above will now be described by way of non-limiting example only, with reference to the accompanying drawings in which:

FIG. 1 shows a method for controlling access to a financial account;

FIG. 2 is a flowchart providing exemplary screenshots of a process for registering to use a method according to FIG. 1;

FIG. 3 is a flowchart providing exemplary screenshots of a process for enabling a particular payment vehicles for use in accordance with the method of FIG. 1;

FIG. 4 is a schematic flowchart showing a method for registering a payment vehicle for use with the method of FIG. 1;

FIG. 5 is a schematic flowchart showing a method of using a payment vehicle in a method according to FIG. 1;

FIG. 6 shows a schematic of a system for performing the method of FIG. 1; and

FIG. 7 shows an exemplary computing device suitable for executing the method of FIG. 1.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “retrieving”, “filtering”, “providing”, “displaying”, “analysing”, “enabling”, “disabling” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

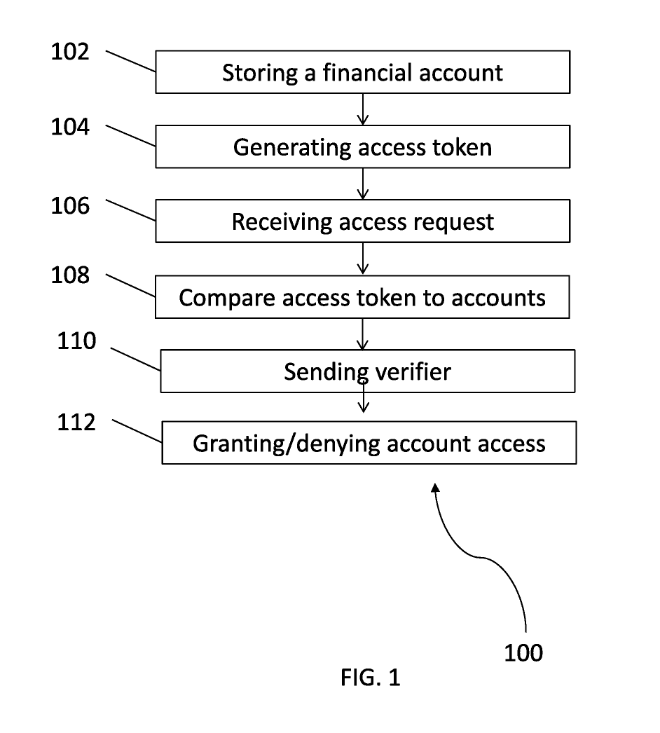

FIG. 1 shows a method 100 for controlling access to a financial account. The method 100 avoids the need for a user (e.g. an ‘account holder’) to send payment vehicle details from their location to a payment network server—for example, a payment scheme server such as a MasterCard® server.

The method 100 includes the steps of:
102: storing a financial account in a database;
104: associating, in the database, an access token with the account;
106: receiving a request to access the account;
108: locating financial account using access token;
110: sending a verifier to the party requesting access to the account; and
112: granting/denying access depending on whether or not the verifier has subsequently been received.

The step (102) of storing a financial account in a database involves a standard account setup process. Such a setup process usually involves a user providing a financial institution with sufficient personal details to enable the user to be identified and contacted. As such, the financial account comprises user details such as a mobile phone number.

In many cases, when establishing an account the user will also acquire a card by which to access that account from various locations. To that end, the financial account also comprises payment vehicle details of one or more payment vehicles. A payment vehicle is, in the present context, any credit or debit card by which funds allocated to a financial account can be used. The payment vehicle details are thus the card number, and other information such as, for example, the expiry date of the card, a card verification value (CVV) and a loyalty or awards scheme account. The card number may be the card number of a physical debit or credit card, a card number of a virtual card number mapped to a physical card, or a virtual card number of a virtual card (e.g. virtual credit card or virtual prepaid card).

Associating a unique access token with the account (step 104) may be achieved in a number of ways. In one embodiment, a piece of information unique to the user, and taken from the user's financial account, may be assigned as the access token. For example, the access token may be the user's mobile phone number, tax file number, social security number or the financial account number. The access token may also be a randomly or algorithmically generated unique number. In being associated with the financial account, the access token may be deemed associated with the payment vehicle details, mobile phone number or other details held in the financial account.

The access token is then stored in the database in association with the financial account. This association may comprise storing the access token as one of the financial account details (e.g. in a similar manner to the user's mobile phone number) or may comprise storing the access token in a separate database, and linking it with the financial account or payment vehicle within the financial account.

Once the user's financial account has been set up and the access token established, transactions and account control processes (i.e. account “access” events or occurrences) can be initiated using the access token. For a user to initiate access to an account the user requests access by entering their access token into the computing system—for example, the user may enter the access token into a POS terminal when seeking to make a transaction, or enter their access token into an ATM when seeking to view account details or make a withdrawal.

A server receives, through the computing system, the request to access the financial account (step 106). The request necessarily includes the access token so that the relevant financial account can be located.

The server locates the financial account by cross-referencing the access token against a database of financial accounts until the financial account in question is located (step 108). Cross-referencing can be achieved using any appropriate search algorithm.

Once the financial account is identified, the server queries the account details to determine whether it comprises payment vehicle details of a payment vehicle that has been activated for controlling account access in accordance with present teachings. If such a payment vehicle is located, the mobile phone number is extracted from the financial account.

Once extracted, a verifier is sent to the mobile phone number. The verifier is employed to verify the user is authorised to access the financial account. In other words, the verifier is used to control access to an account through verification of the party (i.e. the user) requesting such access. In this connection, the phrase “sending [information] to a mobile phone number” and similar, refers to sending the information to the mobile phone associated with the mobile phone number, for example as a data packet, in a text message or multimedia message.

The verifier may thus be sent in a text message, multimedia message or any other form. The verifier may, for example, be sent to a mobile phone messaging app in message form with a viewing time limit before the message self-deletes. This will ensure that the verifier is no longer available for inspection after the period over which it should have been entered into the computing system (e.g. POS or ATM).

Since a mobile phone number will often be known by a number of people, it would not be secure to use the mobile phone number to verify the user's identity. It would also be undesirable to have a user's personal details, such as a tax file number, used to verify the user's identity since whatever is used for verification will be sent over networks of varying levels of security. Thus, while the verifier may comprise any known or unknown detail of the user, the verifier in the present embodiment comprises a random string or sequence. The string or sequence may comprise numeric, alphabetical, non-alphanumeric characters or a combination thereof. The string or sequence is generated when an access request is received.

Once the user receives the verifier to their mobile phone, they enter the verifier into the computing system (e.g. POS terminal or ATM).

Access to the financial account—for example, for the purpose of making a transaction at a POS terminal or viewing account details through an ATM—is granted if the verifier is subsequently received, by the server, through the computing system. If the verifier is not received by the server through the computing system, access to the financial account is denied.

A time limit for entering the verifier may be set. The time limit may be any desired period—for example, one minute, three minutes or any other appropriate period. The time limit may be matched to a period for self-destruction on the message carrying the verifier.

Since the present process relies on the party making the transaction having the user's mobile phone, and being able to access the functions of that phone, the present method is secure despite the user's mobile phone number being transmitted over networks that may not be secure.

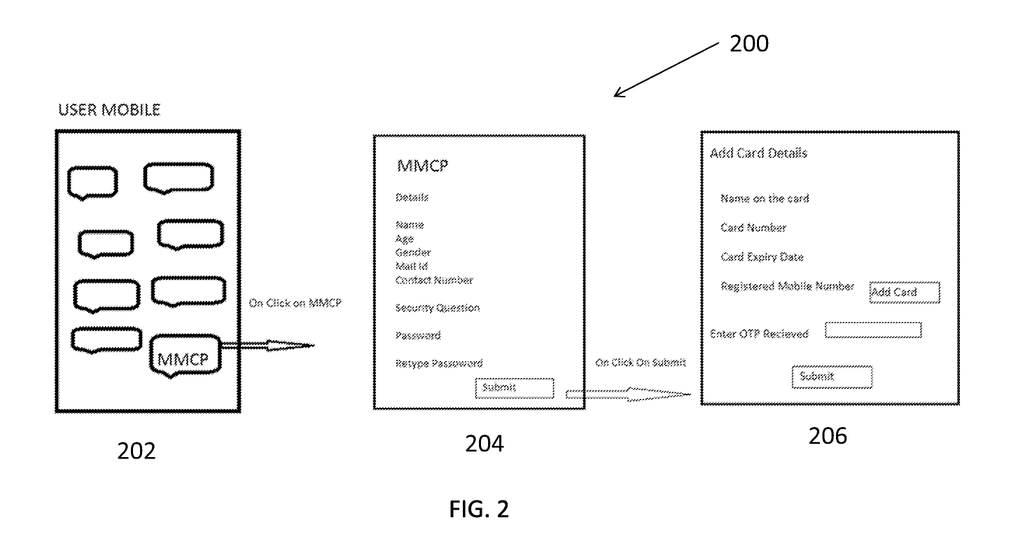

With reference to FIG. 2, a flowchart 200 is shown, illustrating a process for registering for use of the method of FIG. 1. The process broadly involves the steps of:
202: installation and opening of mobile app;
204: account setup; and
206: card enablement.

The process for downloading and installing a mobile app (step 202) is taken to be known.

Setting up an account (step 204) involves establishing a user profile. The user profile may comprise any desired details of, or associated with, the user. For example, the user may be required to complete their profile by entering the name, age, gender, mail address or postcode and their contact number (which will usually be a mobile phone number), a subset of those details and/or additional details.

To ensure no third parties who gain access to the mobile phone are then subsequently able to access the app, the user may enter a security question and/or password. Once one or more payment vehicles have been enabled for use, the app may also be configured to:
remotely disable all payment vehicles to prevent use in the event that the mobile phone is lost or stolen; and/or
only enable use of payment vehicles in the method of FIG. 1 if the app is open.

After entering all relevant details the user hits “Submit” and is then prompted to enter payment vehicle details (step 206). Notably, while FIG. 2 shows a screen for entry of card details, the payment vehicle may similarly comprise a user account since no card needs to be physically present for transactions made in accordance with present teachings. In other words, entry of the user's mobile phone number or other access token into a POS terminal or ATM may initiate a process for debiting a savings account of the user, and transmitting the debited amount to the party who would otherwise have received funds through use of a debit or credit card.

After entry of the card details, the user enters the mobile phone number registered in the financial account in which the card (or other payment vehicle) details are held. The server locates the account using one of the card number or mobile phone number, and checks that it matches with the other of the card number and mobile phone number. If there is no match the app returns an error message. If there is a match, the server sends a verifier (e.g. a one-time password (OTP)) to the registered mobile phone. The user then enters the verifier and presses “Submit”.

FIG. 2 therefore illustrates the process of account registration and activating a payment vehicle for use in the method shown in FIG. 1.

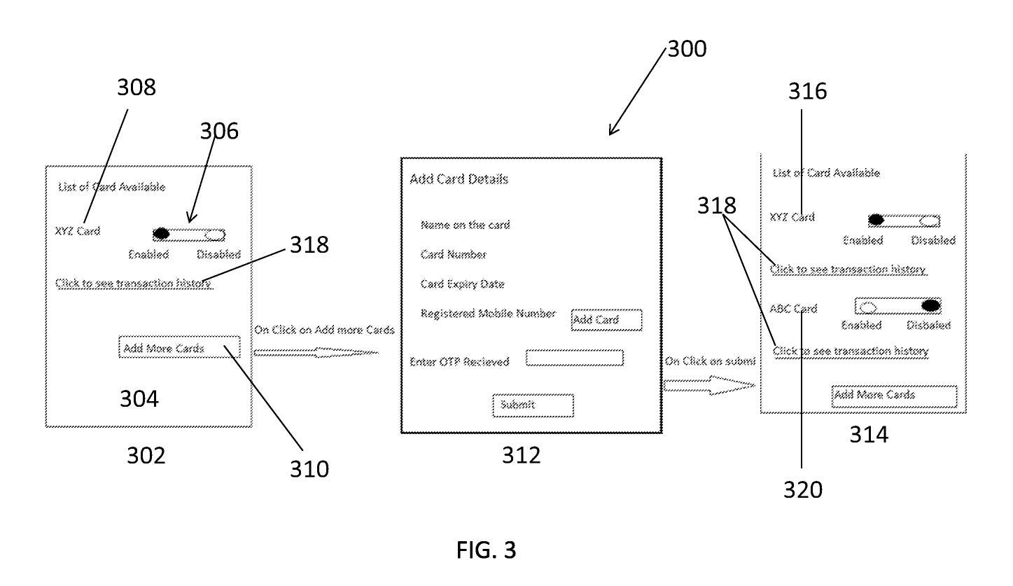

Once activated, the payment vehicle can be selectively enabled and disabled for use with the method of FIG. 1. FIG. 3 shows a process flow 300 for enabling and disabling payment vehicles for use with the method of FIG. 1, and for activating more than one payment vehicle for use with that method.

Step 302 of the flowchart 300 comprises an illustrative screenshot 304 of the app downloaded and installed in accordance with step 202. The screenshot 304 identifies the payment vehicle 306 activated in step 206, and a selective enablement switch 308. The selective enablement switch 308 presently comprises a pair of radio buttons one labelled “enable” and the other labelled “disable”.

The “enable” radio button is highlighted, indicating the payment vehicle is ready for use in the method of FIG. 1.

The user may desire to enable more than one payment vehicle. For example, the user may have one credit and debit card for personal use, and a credit card for business use. The user may therefore wish to add further payment vehicles and may do so by selecting the “Add More Cards” button 310.

To add further payment vehicles the user must enter the same information into the screen indicated by 312, and go through the same process, as described with reference to step 206 of FIG. 2.

FIG. 3 shows a screenshot 314 of the app with multiple activated payment vehicles. Once multiple payment vehicles are enabled, the app may permit multiple payment vehicles to remain concurrently enabled. However, in some cases this may give rise to a conflict where a POS terminal, for example, does not know which payment vehicle is intended for a particular transaction. To avoid such conflicts, enabling one payment vehicle (e.g. XYZ card 316) for use with the method of FIG. 1 disables all other payment vehicles (e.g. ABC card 320) for that purpose. This does not deactivate other payment vehicles for use in other processes—for example, a credit card disabled using the app the screenshots for which are shown in FIG. 3 is not disabled for making purchases directly (e.g. physically using the card or entering the card number into an online payment gateway).

An additional feature is the ability to see the transaction history for each payment vehicle. This is accessible through transaction history links 318. The transaction history may be extracted directly from the records of the financial institution through whom the payment vehicle was obtained. The transaction history may be limited, selectively or by default, to those transactions made using the methods taught herein.

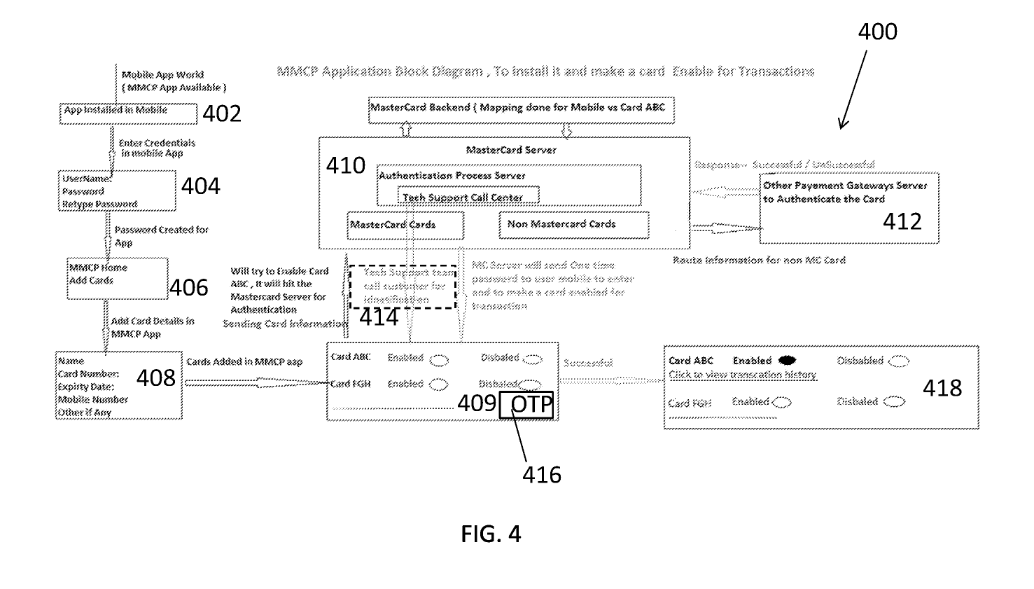

Detailed flowchart 400, illustrated in FIG. 4, demonstrates the interaction between various processes and machines necessary to perform a method for controlling financial account access. The flowchart 400 commences (at 402) with the download and installation of an app for controlling enablement of payment vehicles for use in the method of FIG. 1. A profile is set up (at 404) in accordance with the practice described with reference to screenshot 204. The user then selects to add a new payment vehicle (at 406), and adds a payment vehicle (at 408) in the manner discussed in relation to step 206.

The app then displays—on the screen of the smartphone or other device on which the app is installed—all payment vehicles intended to be used for transactions using methods presented herein (409). When an attempt is made to enable one of the payment vehicles, a request to enable the payment vehicle is sent to an authentication server 410. The request may be accompanied by details of the payment vehicle and mobile phone details that are entered (at 408).

For cards issued through the host of the authentication server, either as an issuer or as a partner or agent of the issuer, the server maps the payment vehicle details and mobile phone number, and/or other details in the user's profile, to a financial account accessible through the server. If both pieces of information match the same account the user is authenticated. If there is a discrepancy—in other words, the pieces of information do not match the same account—the authentication process fails and an authentication declined message is sent to the app. The app then presents an error message advising the user of the failed attempt at authorization. If the user is authenticated, a OTP is sent to the mobile phone number registered with the payment vehicle.

The same authentication process can be used for payment vehicles that are not registered with the host server. In these cases, the payment vehicle details and any other desired details, such as the users mobile phone number or details extracted from the user profile, are sent to the server maintained by the issuer of the payment vehicle or acquirer through whom the payment vehicle was issued. The issuer or acquirer then authenticates the user by matching details to a user financial account (step 412).

Even where the user would otherwise be authenticated there may be circumstances in which the authenticity of the user is in question. In such cases, a technical support person may call the user to confirm their identity before approving verification of the user and the payment vehicle (step 414). Where, for example, the user is accessing the authentication server from a location where the user is not expected to be located then a technical support person may call the user to ask questions to confirm the user's identity.

Once authenticated, the OTP is sent to the mobile phone number associated with the financial account comprising the relevant payment vehicle. Notably, the mobile phone number registered in the financial account for use with present methods may differ from the mobile phone number sent with the payment vehicle details. While this is unlikely, a user may have multiple mobile phones (e.g. one for business use and one for personal use), and similarly have personal and business-related credit cards or other payment vehicles, yet seek verification for use all payment vehicles through a single instance of the app.

Once the OTP is received by the user, it is entered into text box 416 in the app and is thereby received as a verification request by the server 410. Once verified, the payment vehicle is enabled for use with present methods.

Multiple payment vehicles may be similarly verified. Alternatively, a single request may be sent from the app to the server, requesting verification of all relevant payment vehicles. A single OTP will then be sent to the relevant mobile phone number to verify the user. Once that OTP is received through the app, all relevant payment vehicles will be verified and activated for use in the present methods.

Once multiple payment vehicles have been verified, the user can then elect which payment vehicle to enable, of one or more payment vehicles activated for use in accessing a financial account in accordance with present teachings.

The verified payment vehicles can then be selectively enabled, accessed for transactions such as in the operation of ATMs, to review transaction histories and other processes (418).

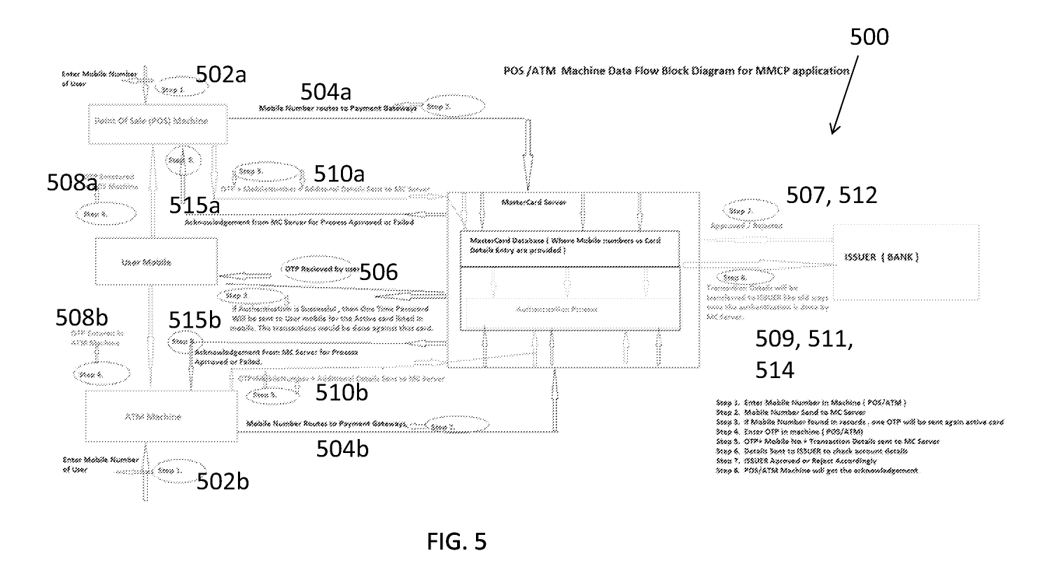

Two such use cases are illustrated in the flowchart 500 in FIG. 5. At step 502a the user enters their mobile phone number into a POS terminal. Similarly, at step 502b the user enters their mobile phone number into an ATM. For illustrative purposes, the access token described with reference to FIG. 5 will be the user's mobile phone number, though other access tokens can be used as necessary.

Once entered, the mobile phone number is routed (504a, 504b) to a verification server (e.g. a server hosted by a payment scheme, acquirer, issuer or other host). The verification server verifies the mobile phone number. In order to use a mobile phone number as a means for accessing POS or ATM functionality, it must previously have been authenticated. The verification process may thus involve cross-referencing the mobile phone number against previously authenticated mobile phone numbers associated with financial accounts and registered for use in methods in accordance with present teachings. The verification process may alternatively involve cross-referencing the mobile phone number against all mobile phone numbers registered with financial accounts.

If a match is found (i.e. the mobile phone number received through the POS terminal or ATM matches a mobile phone number registered for present purposes) then a verifier such as a OTP is sent to the mobile phone number (506).

Where no match is found, the verification server may send the mobile phone number to one or more other servers for verification (507). The one or more other servers may be each hosted by an issuer of payment vehicles, an acquirer or other financial institution.

The host or hosts of the one or more other servers then cross-reference the mobile phone number against numbers registered in their databases for use with methods in accordance with present teachings. If one such server matches the mobile phone number to a relevant financial account the one such server sends a OTP to the mobile phone number. Alternatively, the one such server may send a verification message back to the verification server (509), authorising the verification server to send a OTP to the mobile phone number.

In a further iteration, each of the one or more other servers may send an acknowledgement or declination message to the verification server (511). The acknowledgement message indicates the mobile phone number matches a record on the database of a particular server. The declination message advises that no such match was located.

In this further iteration, the verification server waits until it has received an acknowledgement or declination message from each of the one or more servers. If one of the one or more other servers sends an acknowledgement message, a OTP is sent to the mobile phone number. If no acknowledgement message is received, the verification server sends a message to the POS terminal or ATM advising that the verification process has been unsuccessful. If two or more such acknowledgement messages are received, the verification server sends a message to the POS terminal or ATM advising that the verification process has been unsuccessful and may also advise of a conflict (i.e. that the mobile phone number is registered against multiple financial accounts and, as such, it is unclear which account is intended to be used).

The user then enters the verifier into the POS terminal or ATM (508a, 508b).

The verifier and mobile phone number are then sent to the server (510a, 510b). The mobile phone number is sent so that the computing system (e.g. ATM or POS terminal) can match the verifier to the previously sent mobile phone number and thereby to the financial account associated with the mobile phone number. Thus the ATM or POS terminal must comprise, or be in communication with, a memory for storing the mobile phone number or other access token until it is required for sending with the verifier.

For some transactions, such as when authorising access to an ATM, only the verifier and mobile phone number need to be sent. Additional details are required for other transactions, such as purchase transactions made through a POS terminal. Purchase transactions may be accompanied by purchase details—for example, transaction amount, purchase basket, merchant identifier (e.g. the merchant name, location and other details) and any other details that would usually be necessary to process payment. The additional details are sent along with the verifier and mobile phone number.

For purchase transactions or other transactions involving funds (e.g. ATM withdrawals), the verification server transmits the verified mobile phone number and purchase details to a server hosted by the issuer bank. Where the verification server is hosted by a payment scheme, the payment scheme will know the payment vehicle details of cards that are issued through it and enabled for use in conjunction with entry of the mobile phone number into a POS terminal or ATM. The issuer will similarly be known to the payment scheme. So the payment scheme can send the purchase details, along with one or both of the mobile phone number and payment vehicle details, to the issuer (512). The issuer can then confirm there are sufficient funds in the account (credit or debit) associated with the payment vehicle, to fulfill the desired transaction. The issuer sends a message (514) to the verification server advising whether or not there are sufficient funds to complete the desired transaction—in other words, whether or not the transaction is approved or declined. The verification server then sends a transaction approved or declined message to the POS terminal or ATM, advising whether or not the requested transaction (e.g. purchase or withdrawal) can be completed (515a).

Where no funds transferral or purchase transaction has been initiated before verification of the user (e.g. when a user seeks to access the functions of an ATM other than funds withdrawal), once the details have been sent per step 510a, 510b, the verification server verifies the identity of the user by cross-referencing the mobile phone against mobile phone numbers registered for use in methods according to FIG. 1 and, once a match is found, determines whether the OTP matches the OTP sent to the mobile phone number at step 506.

If the OTP matches an OTP sent to the corresponding mobile phone number, and has been received within any time limits and other conditions set for the OTP, the verification server sends an acknowledgement to the ATM (515b). The acknowledgement advises the ATM of the success or failure of the verification process. If the user is verified, then access to the ATM is granted.

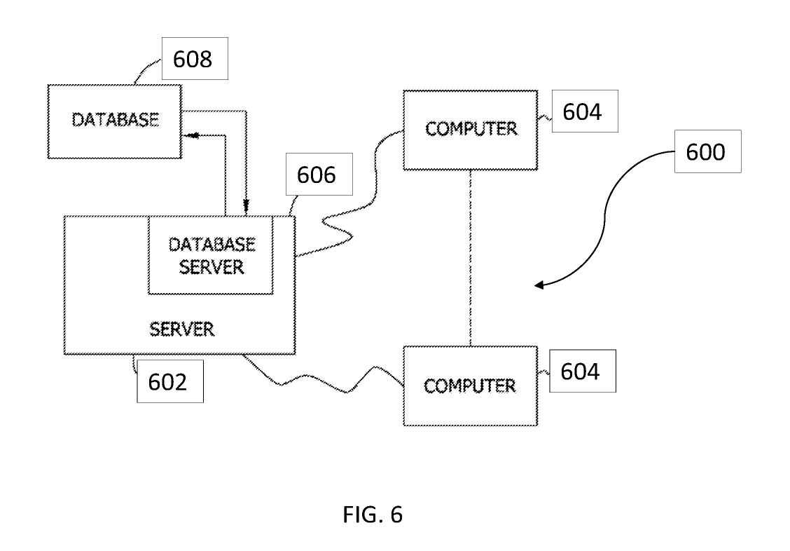

FIG. 6 is a simplified block diagram of an exemplary network-based system 600 that may be used for controlling financial account access. System 600 is a client/server system that may be utilized for storage and delivery of data. More specifically, in the example embodiment, system 600 includes a server system 602, and at least one client computer system 604. The server system 602 may comprise the system of a financial institution, payment scheme or services provider for implementing the method of FIG. 1. The client computer system or system 604 may be the systems of individual merchants in the case of use of the method of FIG. 1 in conjunction with a POS terminal, individual financial institutions in the case of use of the method of FIG. 1 in conjunction with an ATM or a personal electronic device (e.g. smart phone, tablet, laptop or personal computer) where the method of FIG. 1 is being used to make purchases on an app or online. Presently the system 600 includes a plurality of client sub-systems, also referred to as client computer systems 604, connected to server system 602. Client systems 604 may be interconnected to the Internet through a variety of interfaces including a network, such as a local area network (LAN) or a wide area network (WAN), dial-in-connections, cable modems and special high-speed. ISDN lines, Client systems 604 could be any device capable of interconnecting to the Internet including a personal computer (PC), a web-based phone, personal digital assistant (PDA), or other web-based connectable equipment.

A database server 606 is connected to database 608, which contains information such as financial accounts and lists of mobile phone numbers registered for use with the method of FIG. 1. In one embodiment, centralized database 608 is stored on server system 602 and can be accessed by potential users (e.g. merchants via POS terminals) at one of client systems 604 by logging onto server system 602 through one of client systems 604. In an alternative embodiment, database 608 is stored remotely from server system 602 and may be non-centralized. Database 608 may store electronic files. Electronic files may include transaction data, financial accounts, electronic documents, web pages, other image files and/or electronic data of any format suitable for storage in database 608 and delivery using system 600.

More specifically, database 608 may store financial accounts comprising details of enabled payment vehicles and registered mobile phone numbers, and transaction level data for populating transaction histories over a network of client systems 604.

The system 600 may be administered by a card issuer or payment scheme, and thus be involved in the provision of financial services over a network. In this manner, the system 600 can manage the registration of mobile phone numbers and other access tokens for use in the present methods, manage transactions made in accordance with the present methods, and thereby collect data relating to merchants, account holders or customers, developers, issuers, acquirers, purchases made, and services provided by system 600 and systems and third parties with which the system 600 interacts. For example, server system 602 could be in communication with an interchange network. The server system 600 may also be able to collect transaction details of transactions made using the present methods and those made using traditional methods, and selectively display—on the screen of a smartphone or other device comprising the client computer 604—either all transactions made using a particular payment vehicle—upon selection of, for example, link 318—or only those transactions made using the present methods.

Similarly, database 608 may also store financial account data including at least one of a cardholder name, a cardholder address, an account number, a mobile phone number and other account details. Database 608 may also store merchant data including a merchant identifier that identifies each merchant registered on the network, and instructions for settling transactions using a method according to FIG. 1.

The database 608 may also be a non-transitory computer readable medium storing or embodying a computer program for controlling financial account access. The program may include at least one code segment executable by a computer to instruct the computer to perform a method as described herein, for example with reference to FIG. 1.

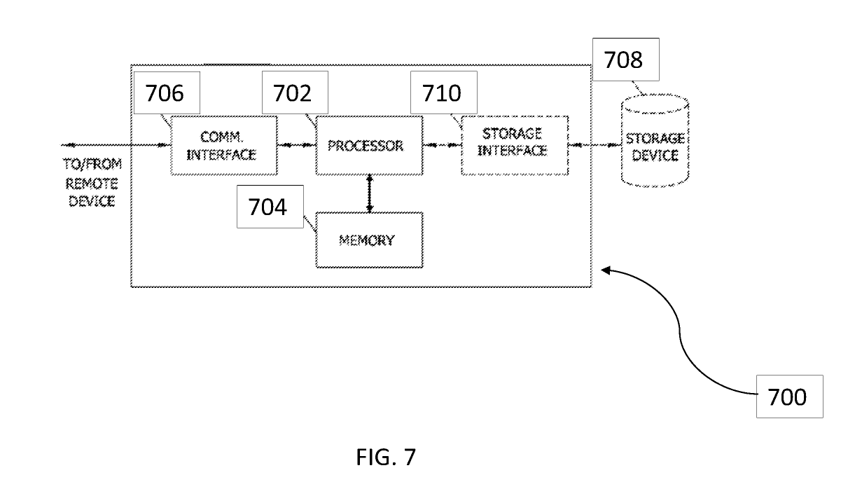

FIG. 7 illustrates an exemplary configuration of a computing device 700, similar to server system 600 (shown in FIG. 6). Computing device 700 may include, but is not limited to, issuer server, payment scheme server, database server, application server, web server, fax server, directory server, and mail server.

Server computing device 700 also includes a processor 702 for executing instructions. Instructions may be stored, for example, in a memory area 704 or other computer-readable media. Processor 702 may include one or more processing units (e.g., in a multi-core configuration).

Processor 702 may be operatively coupled to a communication interface 706 such that server computing device 700 is capable of communicating with a remote device such as user computing device 604 (shown in FIG. 6) or another server computing device 700. For example, communication interface 706 may receive requests from client system 604 via the Internet.

Processor 702 may also be operatively coupled to storage device 708. Storage device 708 is any computer-operated hardware suitable for storing and/or retrieving data. In some embodiments, storage device 708 is integrated in server computing device 700. For example, server computing device 708 may include one or more hard disk drives as storage device 708. In other embodiments, storage device 708 is external to server computing device 700 and may be accessed by a plurality of server computing devices 700. For example, storage device 708 may include multiple storage units such as hard disks or solid state disks in a redundant array of inexpensive disks (RAID) configuration. Storage device 708 may include a storage area network (SAN) and/or a network attached storage (NAS) system.

In some embodiments, processor 700 is operatively coupled to storage device 708 via a storage interface 710. Storage interface 710 is any component capable of providing processor 702 with access to storage device 708. Storage interface 710 may include, for example, an Advanced Technology Attachment (ATA) adapter, a Serial ATA (S ATA) adapter, a Small Computer System Interface (SCSI) adapter, a RAID controller, a SAN adapter, a network adapter, and/or any component providing processor 702 with access to storage device 708.

In operation, the processor 702, coupled to a memory device (including memory device 704 and storage device 708), is configured to store at least one financial account in a database, each financial account comprising details of at least one payment vehicle and a mobile phone number. The processor is configured to thereafter associate a unique access token with the financial account.

For use after the access token has been associated with the financial account (e.g. by being stored in association with the financial account in storage device 708, which may be a single database or multiple databases), the processor is also configured to receive, through a computing system, a request to access the financial account, the request comprising the access token, cross-reference the access token against the database, to identify the financial account associated with the access token, and identify the mobile phone number from the financial account. For verification to take place, the processor is configured to send, to the mobile phone number, a verifier for verifying the user is authorised to access the financial account, and grant access to the financial account through the computing system if the verifier is subsequently received through the computing system, and denying access to the financial account if the verifier is not subsequently received through the computing system.

When the request comprises a request to complete a purchase transaction, and the request includes a transaction amount, the processor may be configured to verify there are sufficient funds in the financial account to fulfill the purchase transaction, and send a transaction approval message to the computing system approving the transaction if there are sufficient funds in the financial account to fulfill the purchase transaction or, alternatively, send a transaction declination message to the computing system declining the transaction if there are insufficient funds in the financial account to fulfill the purchase transaction. Of course, the processor will be configured to send both an approval message and a declination message, though only one such message will be sent in any particular case.

The computer system 700 may be instructed by a computer program embodied on a non-transitory computer readable medium, such as memory device 704 or storage device 708. The program stored on the device 704, 708 would include at least one code segment, and most likely many thousands of code segments, executable by a computer to instruct the computer to perform the requested operations.

Similarly, the program may be stored remotely. To this end, the computer system may constitute a client computer system of a network-based system for performing the above methods.

Many modifications and variations of the present teachings will be apparent to the skilled person in light of the present disclosure. All such modifications and variations are intended to fall within the scope of the present disclosure. Moreover, to the extent possible, features form one of the embodiments described herein may be used in one or more other embodiments to enhance or replace a feature of the one or more other embodiments. All such usage, substitution and replacement is intended to fall within the scope of the present disclosure.

1. A computer-implemented method for controlling financial account access, the method comprising the steps of:
storing a financial account in a database, the financial account comprising details of one or more payment vehicles and a mobile phone number;
associating, in the database, a unique access token with the financial account;
receiving, through a computing system, a request to access the financial account, the request comprising the access token;
cross-referencing the access token against the database, to identify the financial account associated with the access token, and identifying the mobile phone number from the financial account;
sending, to the mobile phone number, a verifier for verifying the user is authorised to access the financial account; and
granting access to the financial account through the computing system if the verifier is subsequently received through the computing system, and denying access to the financial account if the verifier is not subsequently received through the computing system.

2. A computer-implemented method according to claim 1, wherein the access token is the mobile phone number.

3. A computer-implemented method according to claim 1, further comprising enabling a first payment vehicle for use with requests to access the financial account, wherein such requests comprise the access token.

4. A computer-implemented method according to claim 3, wherein enabling the first payment vehicle comprises:
checking whether any further payment vehicles of the one or more payment vehicles have been enabled for use with requests comprising the access token; and
enabling the first payment vehicle for use with requests comprising the access token if there are no further payment vehicles.

5. A computer-implemented method according to claim 4, wherein, where one or more further payment vehicles have been enabled for use with requests comprising the access token, the method further comprises:
disabling the one or more further payment vehicles to prevent the one or more further payment vehicles from being used with requests comprising the access token; and
enabling the first payment vehicle for use with requests comprising the access token.

6. A computer-implemented method according to claim 3, wherein the request comprises a request to complete a purchase transaction, the request including a transaction amount.

7. A computer-implemented method according to claim 6, further comprising:
identifying the first payment vehicle by cross-referencing the access token against the database, to identify the financial account associated with the access token, and thereby identify the first payment vehicle from the financial account.

8. A computer-implemented method according to claim 7, further comprising:
determining if the first payment vehicle has sufficient available funds to fulfill the purchase transaction.

9. A computer-implemented method according to claim 8, further comprising sending a transaction approval message to the computing system approving the transaction if the first payment vehicle has sufficient available funds to fulfill the purchase transaction.

10. A computer-implemented method according to claim 8, further comprising sending a transaction declination message to the computing system declining the transaction if the first payment vehicle has insufficient available funds to fulfill the purchase transaction.

11. A computer-implemented method according to claim 3, wherein the requests comprises a request to access an automated teller machine.

12. A computer system for controlling financial account access, the computer system comprising:
a non-transitory memory device for storing data;
a display; and
a processor coupled to the memory device and being configured to:
store a financial account in a database, the financial account comprising details of one or more payment vehicles and a mobile phone number;
associate, in the database, a unique access token with the financial account;
receive, through a computing system, a request to access the financial account, the request comprising the access token;
cross-reference the access token against the database, to identify the financial account associated with the access token, and identifying the mobile phone number from the financial account;
send, to the mobile phone number, a verifier for verifying the user is authorised to access the financial account; and
grant access to the financial account through the computing system if the verifier is subsequently received through the computing system, and denying access to the financial account if the verifier is not subsequently received through the computing system.

13. A computer system according to claim 12, wherein the processor is further configured to enable a first payment vehicle for use with requests to access the financial account, wherein such requests comprise the access token.

14. A computer system according to claim 13, wherein the processor is configured to enable the first payment vehicle by:
checking whether any further payment vehicles of the one or more payment vehicles have been enabled for use with requests comprising the access token; and
enabling the first payment vehicle for use with requests comprising the access token if there are no further payment vehicles.

15. A computer system according to claim 14, wherein the processor is further configured such that, where one or more further payment vehicles have been enabled for use with requests comprising the access token, the processor further:
disables the one or more further payment vehicles to prevent the one or more further payment vehicles from being used with requests comprising the access token; and
enables the first payment vehicle for use with requests comprising the access token.

16. A computer system according to claim 13, wherein the request comprises a request to complete a purchase transaction, the request including a transaction amount.

17. A computer system according to claim 16, wherein the processor is further configured to:
identify the first payment vehicle by cross-referencing the access token against the database, to identify the financial account associated with the access token, and thereby identify the first payment vehicle from the financial account.

18. A computer system according to claim 17, wherein the processor is further configured to:
determine if the first payment vehicle has sufficient available funds to fulfill the purchase transaction;
send a transaction approval message to the computing system approving the transaction if the first payment vehicle has sufficient available funds to fulfill the purchase transaction; and
send a transaction declination message to the computing system declining the transaction if the first payment vehicle has insufficient available funds to fulfill the purchase transaction.

19. A computer program embodied on a non-transitory computer readable medium for controlling financial account access, the program comprising at least one code segment executable by a computer to instruct the computer to:
store a financial account in a database, the financial account comprising details of one or more payment vehicles and a mobile phone number;
associate, in the database, a unique access token with the financial account;
receive, through a computing system, a request to access the financial account, the request comprising the access token;
cross-reference the access token against the database, to identify the financial account associated with the access token, and identifying the mobile phone number from the financial account;
send, to the mobile phone number, a verifier for verifying the user is authorised to access the financial account; and
grant access to the financial account through the computing system if the verifier is subsequently received through the computing system, and denying access to the financial account if the verifier is not subsequently received through the computing system.

20. A computer program according to claim 19, further comprising at least one code segment executable by a computer to instruct the computer to enable a first payment vehicle for use with requests to access the financial account, wherein such requests comprise the access token.

21. A computer program according to claim 20, further comprising at least one code segment executable by a computer to instruct the computer to enable the first payment vehicle by:
checking whether any further payment vehicles of the one or more payment vehicle have been enabled for use with requests comprising the access token; and
enabling the first payment vehicle for use with requests comprising the access token if there are no further payment vehicles.

22. A computer program according to claim 21, further comprising at least one code segment executable by a computer to instruct the computer to:
disable the one or more further payment vehicles to prevent the one or more further payment vehicles from being used with requests comprising the access token; and
enable the first payment vehicle for use with requests comprising the access token, where one or more further payment vehicles have been enabled for use with requests comprising the access token.

23. A computer program according to claim 20, wherein the request comprises a request to complete a purchase transaction, the request including a transaction amount.

24. A computer program according to claim 23, further comprising at least one code segment executable by a computer to instruct the computer to:
identify the first payment vehicle by cross-referencing the access token against the database, to identify the financial account associated with the access token, and thereby identify the first payment vehicle from the financial account.

25. A computer program according to claim 24, further comprising at least one code segment executable by a computer to instruct the computer to:
determine if the first payment vehicle has sufficient available funds to fulfill the purchase transaction;
send a transaction approval message to the computing system approving the transaction if the first payment vehicle has sufficient available funds to fulfill the purchase transaction; and
send a transaction declination message to the computing system declining the transaction if the first payment vehicle has insufficient available funds to fulfill the purchase transaction.
